(19) United States
(12) Patent Application Publication
(10) Pub. No.: US 2025/0094797 A1
(43) Pub. Date: Mar. 20, 2025

(54) System and Method for Constructing Neural Networks Equivariant to Arbitrary Matrix Groups Using Group Representations and Equivariant Tensor Fusion

(71) Applicant: Mitsubishi Electric Research Laboratories, Inc., Cambridge, MA (US)

(72) Inventors: Suhas Lohit, Arlington, MA (US); Sourya Basu, Champaign, IL (US); Matthew Brand, Newton, MA (US)

(73) Assignee: Mitsubishi Electric Research Laboratories, Inc., Cambridge, MA (US)

(21) Appl. No.: 18/590,358

(22) Filed: Feb. 28, 2024

Related U.S. Application Data
(60) Provisional application No. 63/584,104, filed on Sep. 20, 2023.

(51) Int. Cl. G06N 3/08; G06N 3/04

(52) U.S. Cl. CPC G06N 3/08; G06N 3/04

(57) ABSTRACT

A robust machine learning system is provided for robust machine learning. The robust machine learning system includes a processor, and a memory storing a robust machine learning program and a Group Representation Network (GRepsNet), wherein the robust machine learning program runining on the processor. In this case the processor is configured to receive an input dataset represented by a first group representation via input layers connected to the GrepsNet, pass/transmit the input dataset through the GRepsNet configured to generate an output dataset represented by an output group representation from the input dataset, wherein the output group is equivalent to the first group, and generate the output dataset from output layers connected to the GRepsNet.

### FIELD OF THE INVENTION

The present invention is related generally to system and method for robust machine learning systems and, particularly, to group-equivariant neural networks for applications like image classification and predicting dynamics.

### BACKGROUND OF THE INVENTION

Equivariant neural networks are neural networks that are exactly equivariant to certain input transformations (usually group transformations). Equivariant neural networks usually have the advantage of needing fewer training data samples and have guarantees of robustness to transformation that they are designed to be equivariant to. For example, Convolutional Neural Networks (CNNs) are equivariant to translations by design, that is, if the input to the CNN is translated, all the hidden feature maps are also translated by the same/similar amount. The set of translations forms, along with vector addition to compose two translations forms an algebraic structure called a “group”. This idea of equivariance can be generalized to other groups such as rotations to form equivariant neural networks.

However, constructing efficient equivariant networks for general groups and domains is difficult. Although a prior method directly solves the equivariance constraint for arbitrary matrix groups to obtain equivariant Multilayer Perceptrons (EMLPs), this method does not scale well.

Accordingly, there is a need to develop a system and method that can construct, given the right group representations for input data, provide neural networks that are equivariant to arbitrary matrix groups and are easily scalable to larger networks as well as diverse architectures such as Multilayer Perceptrons (MLPs), CNNs, MLP Mixers, etc.

### SUMMARY OF THE INVENTION

Some embodiments of the present invention are based on recognition that group equivariance is a strong inductive bias useful in a wide range of domains including images, point clouds, dynamical systems, and partial differential equations (PDEs). Scaling is crucial for deep learning. This necessitates the design of group equivariant networks for general domains and groups that are simple and scalable. To this end, the present disclosure describes a robust machine learning system using Group Representation Networks (GRepsNets), a simple equivariant network for arbitrary matrix groups. The key intuition behind the design in some embodiments of the present invention is that using tensor representations in the hidden layers of a neural network along with appropriate mixing of various representations can lead to expressive equivariant networks, which we confirm empirically. The robust machine learning system using GRepsNet in the present invention is competitive to EMLP on several tasks with group symmetries such as O(5), O(1, 3), and O(3) with scalars, vectors, and second-order tensors as data types. Some embodiments of the present invention are used for image classification with MLP-Mixers, predicting N-body dynamics using message passing neural networks (MPNNs), and for solving PDEs using Fourier Neural Operators (FNOs). Further, in some embodiments, higher-order tensor representations in in the present invention can be used for group equivariant finetuning that outperforms the existing equivariant finetuning method.

One of the objectives of the present invention is to provide a system and method that can construct, give the right group representations for input data, and provide neural networks that are equivariant to arbitrary matrix groups and are easily scalable to larger networks as well as diverse architectures such as Multilayer Perceptrons (MLPs), CNNs, MLP Mixers, etc.

For instance, the group representations may be forms of datasets, such as tensors, scalars, matrix, vectors, or pixel dataset of images. Further, “group” can be types of data processing, data transformation, data conversion, and data processing, including an algebraic structure, e.g., translation of datasets (T (n)), rotation of datasets (SO(n)), rotations and reflections (O(n)), and Lorentz group (O(1, n)).

Different prior art solutions have different drawbacks. Parameter sharing methods are restricted to discrete groups. Steerable networks are generally difficult to construct and are computationally expensive. Vector Neurons also use a simple group representation as input and use scalar weights to combine these representations and using non-linearities that respect their equivariance. However, it is designed only for SO(3) group and uses only first-ordered tensor representations, i.e., vectors. Frame-averaging methods involve averaging over any frame or the use of auxiliary equivariant networks which increases computational complexity.

To overcome drawbacks of earlier methods, the present disclosure describes a robust machine learning system in which Group Representation Networks (GRepsNet) is the core component. GRepsNet replaces scalar representation from classical neural networks with tensor representations of different orders to obtain expressive equivariant networks. GRepsNet works for arbitrary matrix groups (data Transformation groups) and can also leverage higher-order tensor representations, unlike vector neurons.

The present disclosure provides a simple provably equivariant architecture called GRepsNet, equivariant to arbitrary matrix groups that perform competitively with EMLP on several groups such as O(5), O(3), and SO(1, 3) using scalars, vectors, and second-order tensor representations.

In preferred embodiments, GRepsNet with simple representations works well in conjunction with several architectures used in different domains such as image classification, PDEs, and N-body dynamics predictions using MLP-mixers, FNOs, and MPNNs, respectively.

Some embodiments provide second-order tensor features for equivariant image classification using CNNs. When used for finetuning, it can outperform first-order representations such as those used in equituning.

Some embodiments of the present disclosure provide a robust machine learning system with Group Representation Neural Network (GRepsNet) as its core deep neural network architecture, which can be an equivariant architecture for arbitrary matrix groups that is simple to construct and is scalable.

According to some embodiments of the present disclosure, a robust machine learning system is provided. The robust machine learning system may include a processor, and a memory storing a robust machine learning program and a Group Representation Network (GRepsNet), wherein the robust machine learning program running on the processor, wherein the processor is configured to: receive an input dataset represented by input group representations via input layers connected to the GrepsNet; transmit the input dataset through the GRepsNet configured to generate outputs represented by an output group representation from the input dataset, wherein the GRepsNet is designed to be equivariant to the transformation group.

Further, some embodiments of the present invention provide a data transformation system. The system may include a memory configured to store a Group Representation Network (GRepsNet) and a set of instructions for data transformations using the GRepsNet; and a processor coupled to the memory and configured to perform the set of instructions including steps of: providing an input dataset represented by an input group representation into input layers connected to a Group Representation Network (GRepsNet); transforming the input dataset by using the GRepsNet configured to generate an output dataset represented by an output group representation from the input dataset, wherein the GRepsNet is designed to be equivariant to a predetermined transformation group; and outputting the output dataset from output layers connected to the GRepsNet.

Yet further, some embodiments provide a computer-implemented method for a robust machine learning implemented in a computing system including a processor, and a memory storing a robust machine learning program and a Group Representation Network (GRepsNet), wherein the robust machine learning program running on the processor, wherein the computer-implemented method comprises: receiving an input dataset represented by input group representations via input layers connected to the GrepsNet; transmitting the input dataset through the GRepsNet configured to generate outputs represented by an output group representation from the input dataset, wherein the GRepsNet is designed to be equivariant to the transformation group.

### BRIEF DESCRIPTION OF THE DRAWINGS

The present disclosure is further described in the detailed description which follows, in reference to the noted plurality of drawings by way of non-limiting examples of exemplary embodiments of the present disclosure, in which like reference numerals represent similar parts throughout the several views of the drawings. The drawings shown are not necessarily to scale, with emphasis instead generally being placed upon illustrating the principles of the presently disclosed embodiments.

While the following identified drawings set forth presently disclosed embodiments, other embodiments are also contemplated, as noted in the discussion. This disclosure presents illustrative embodiments by way of representation and not limitation. Numerous other modifications and embodiments can be devised by those skilled in the art which fall within the scope and spirit of the principles of the presently disclosed embodiments.

FIG. 1A is a block diagram illustrating an embodiment of a data transformation system;

FIG. 1B is a block diagram illustrating an embodiment of a data transformation engine in a data transformation system;

FIG. 2A shows an example of an invariant function equivariant to translations and rotations;

FIG. 2B shows an example of an invariant function equivariant to translations and rotations;

FIG. 3A shows the general architecture of an equivariant neural network and how equivariance can be achieved at its output;

FIG. 3B shows the general architecture of an equivariant neural network and how invariance can be achieved at its output;

FIG. 4 shows an example GRepsNet layer with inputs of types T₀, T₁ and T₂, and outputs of the same type, according to embodiments of the present invention;

FIG. 5 shows the internal configuration of an example GRepsNet layer with 1 T₀(scalar), 3 T₁ (vector) inputs of 4 elements each, and two T₁ outputs, according to embodiments of the present invention;

FIG. 6 shows an example method for building the input group representation for image classification and obtaining rotation-invariant features from a convolutional neural network, according to embodiments of the present invention;

FIG. 7A, FIG. 7B, and FIG. 7C show the results and comparison of GRepsNet with MLP and EMLP for three tasks-(a) O(5)-invariant regression, O(3)-equivariant regression and (c) SO(1,3)-invariant regression for different types of input and output representations, according to embodiments of the present invention;

FIG. 8 shows comparisons of the training time for GRepsNet, MLP, and EMLP for different tasks, according to embodiments of the present invention;

FIG. 9 shows the image classification results on three datasets for MLP-Mixer, GRepsMLP-Mixer-1 and GRepsMLP-Mixer-2, according to embodiments of the present invention;

FIG. 10 shows the results of solving PDEs according to embodiments of the present invention, comparing the performance between FNO, GFNO, GRepsFNO-1 and GRepsFNO-2;

FIG. 11 shows the comparison of the performances between GRepsGNN and EGNN for the experiment on predicting N-body dynamics, according to embodiments of the present invention;

FIG. 12A and FIG. 12B show the effect of using T₂ representations at different depths in the network for rot90-CIFAR10 image classification experiment, according to embodiments of the present invention;

FIG. 13 shows the comparison of the results for Equituning with T₁ versus T₂ representations, according to embodiments of the present invention;

FIG. 14A and FIG. 14B show examples of embodiments of GRepsNet where (a) residual connections are added in a GRepsNet layer and (b) First k layers consist of T₁-layers, then the extracted features are converted into T₂ tensors, which are then processed by T₂-layers, according to embodiments of the present invention; and

FIG. 15 shows an example of a robust machine learning system, according to embodiments of the present invention.

### DETAILED DESCRIPTION OF PREFERRED EMBODIMENTS

The following description provides exemplary embodiments only, and is not intended to limit the scope, applicability, or configuration of the disclosure. Rather, the following description of the exemplary embodiments will provide those skilled in the art with an enabling description for implementing one or more exemplary embodiments. Contemplated are various changes that may be made in the function and arrangement of elements without departing from the spirit and scope of the subject matter disclosed as set forth in the appended claims.

Specific details are given in the following description to provide a thorough understanding of the embodiments. However, understood by one of ordinary skill in the art can be that the embodiments may be practiced without these specific details. For example, systems, processes, and other elements in the subject matter disclosed may be shown as components in block diagram form in order not to obscure the embodiments in unnecessary detail. In other instances, well-known processes, structures, and techniques may be shown without unnecessary detail in order to avoid obscuring the embodiments. Further, like-reference numbers and designations in the various drawings may indicate like elements.

Also, individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process may be terminated when its operations are completed but may have additional steps not discussed or included in a figure. Furthermore, not all operations in any particularly described process may occur in all embodiments. A process may correspond to a method, a function, a procedure, a subroutine, a subprogram, etc. When a process corresponds to a function, the function's termination can correspond to a return of the function to the calling function or the main function.

Furthermore, embodiments of the subject matter disclosed may be implemented, at least in part, either manually or automatically. Manual or automatic implementations may be executed, or at least assisted, through the use of machines, hardware, software, firmware, middleware, microcode, hardware description languages, or any combination thereof. When implemented in software, firmware, middleware or microcode, the program code or code segments to perform the necessary tasks may be stored in a machine-readable medium. A processor(s) may perform the necessary tasks.

### Groups and Representation Theory

A group is a set G along with a binary operator ‘·’, such that the axioms of a group are satisfied: a) closure: g₁·g₂ ∈G for all g₁, g₂ ∈G, b) associativity: (g₁·g₂)·g₃=g₁·(g₂·g₃) for all g₁, g₂, g₃ ∈G, c) identity: there exists e∈G such that e·g=g·e=g for any g∈G, d) inverse: for every g∈G there exists g⁻¹ ∈G such that g·g⁻¹=g⁻¹·g=e.

For a given set X, a group action of a group G on X is defined via a map α: G×X→X such that α(e,x)=xfor all x∈X, and α(g₁, α(g₂, x)=α(g₁·g₂, x) for all g₁, g₂∈G and x∈X, where e is the identity element of G. When clear from context, we write α(g,x) simply as gx.

Given a function ƒ: X→ [symbol] , we call the function ƒ to be G-equivariant if f(gx)=gf(x) for all g∈G and x∈X.

Let GL(m) represent the group of all invertible matrices of dimension m. Then, for a group G, the linear group representation of G is defined as the map ρ:G=→GL(m) such that ρ(g₁g₂)=ρ(g₁) ρ(g₂) and ρ(e)=I, the identity matrix. A group representation of dimension m is a linear group action on the vector space [symbol] ^{m}.

Given some base linear group representation ρ(g) for g∈G on some vector space V, we construct tensor representations by applying Kronecker sum ⊕ Kronecker product ⊗, and tensor dual *. Each of these tensor operations on the vector spaces lead to corresponding new group actions. The group action corresponding to V* becomes ρ(g⁻¹)^{T}. Let β₁(g) and ρ₂(g) for g∈G be group actions on vector spaces V₁ and V₂, respectively. Then, the group action on V₁⊕V₂ is given by β₁(g) ⊕β₂(g) and that on V₁ ⊗V₂ is given by β₁(g) ⊗β₂(g).

Tensors corresponding to the base representation p are denoted as T₁ tensors, i.e., tensors of order one, and T₀ denotes a scalar. In general, Tₘ denotes a tensor of order m. Further, Kronecker product of tensors Tₘ and Tₙ gives a tensor Tₘ₊ₙ of order m+n. We use the notation Tₘ^{⊗r} to denote r times Kronecker product of Tₘ tensors. Kronecker sum of two tensors of types Tₘ and Tₙ gives a tensor of type Tₘ ⊕Tₙ. Finally, Kronecker sum of r tensors of the same type Tₘ is written as rTₘ.

These are four types of provably equivariant networks and how our work is different from them:

Parameter sharing methods: A prior art method for constructing group equivariant architectures involves sharing learnable parameters in the network to guarantee equivariance, e.g. CNNs, GCNNs and Deepsets. However, all these methods are restricted to discrete groups, unlike the present disclosure which can handle equivariance to arbitrary matrix groups.

Steerable networks: Another popular approach for constructing group equivariant networks is by first computing a basis of the space of equivariant functions, then linearly combining these basis vectors to construct an equivariant network. This method can also handle continuous groups. Several popular architectures employ this method, e.g. steerable CNNs, E(2)-CNNs and Tensor Field Networks. But, these methods are computationally expensive and are applicable to specific groups. Equivariant MLP (EMLP) proposes an elegant solution to the equivariant constraint on linear layers for arbitrary matrix groups to compute their basis and construct an equivariant network from the computed basis. Because of the simplicity of the approach in the present disclosure, it can be employed for several larger datasets, which is in contrast to EMLP, where the applications are mostly restricted to toy datasets.

### Equivariant MLP (EMLP)

Given the input and output types for some matrix group, the corresponding tensor representations can be derived from the given base group representation. Using these tensor representations, one can solve for the space of linear equivariant functions directly from the obtained equivariant constraints corresponding to the tensor representations. Recent work proposes a solution to solve these constraints by computing the basis of the linear equivariant space and construct an Equivariant MLP (EMLP) from the computed basis. Our work is closest to this work as we use the same data representations as them, but we propose a much simpler architecture for equivariance to arbitrary matrix groups. Because of the simplicity of our approach, our novel architecture can use it for several larger datasets, which is in contrast to their work, where the experiments are mostly restricted to synthetic experiments. Moreover, using these bases are in general known to be computationally expensive.

Representation-based methods: A simple alternative to using steerable networks for continuous networks is to construct equivariant networks by simply representing the data using group representations, only using scalar weights to combine these representations, and using non-linearities that respect their equivariance. This simple approach is used in vector neurons, which gives remarkably good performance for the SO(3) group. The present disclosure provides a system and a computer-implemented method, which is more general and applicable to arbitrary matrix groups and use higher-order tensor representations, whereas vector neurons use first-ordered tensor representations, i.e., vectors.

### Universal Scalars

Another recent work proposes a method to circumvent the need to explicitly use these equivariant bases. The First Fundamental Theorem of Invariant Theory for the Euclidean group O(d) states that “a function of vector inputs returns an invariant scalar if and only if it can be written as a function only of the invariant scalar products of the input vectors”. Taking inspiration from this theorem and a related theorem for equivariant vector functions, this work characterizes the equivariant functions for various Euclidean and Non-Euclidean groups. They further motivate the construction of neural networks taking the invariant scalar products of given tensor data as inputs. However, the number of invariant scalars for N tensors in a data point grows as N², hence, making it an impractical method for most real life machine learning datasets. Hence, their applications are also mostly restricted to synthetic datasets like in EMLP.

Moreover, they show that even though the number of resulting scalars grow proportional to N², when the data is of dimension d, approximately N×(d+1) number of these scalars is sufficient to construct the invariant function. But, it might not be trivial to find this subset of scalar for real life datasets such as images. Hence, the present disclosure uses deeper networks with equivariant features that directly take the N tensors as input, instead of N² scalar inputs, which also circumvent the need to use equivariant bases.

Yet another approach to obtain group equivariance is to use frame-averaging, where averaging over equivariant frames corresponding to each input is performed to obtain equivariant outputs. This method works for both discrete and continuous groups but requires the construction of these frames, either fixed by design or learned using auxiliary equivariant neural networks. The present disclosure is in general different from this approach since our method does not involve averaging over any frame or the use of auxiliary equivariant networks. For the special case of discrete groups, the notion of frame averaging is closely related to both parameter sharing as well as representation methods. Hence, in the context of “equituning′, we show how higher-order tensor representations can directly be incorporated into their frame-averaging method.

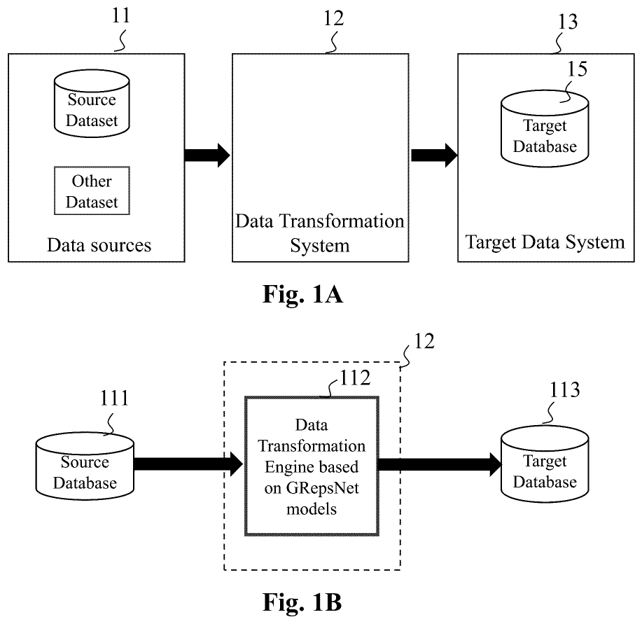

FIG. 1A is a block diagram illustrating an embodiment of a data transformation system. In the figure, a date transformation system 12 receives source data 11, such as a set of data files, one or more source databases, and/or other sources of data, such as a set of data images. In some cases, the data transformation system 12 transforms/converts the data and provides the transformed data to a target data system 13 to be stored in a target database 15. In various embodiments, the data transformation is performed by passing the data through a Group Representation Network (GRepsNet).

FIG. 1B is a block diagram illustrating an embodiment of a data transformation engine in a data transformation system. In the figure, a data transformation engine based on GRepsNet model 112 is included in the data transformation system 12 in FIG. 1A is configured to transform/convert from a source database 111 and output to a target database 113.

In some embodiments, the data transformation engine 112 can be stored in a non-transitory computer-readable medium. In this case, the non-transitory computer-readable medium stores thereon a set of instructions for data transformations. When the set of instructions are performed by one or more processors, the set of instructions cause the one or more processors to at least provide an input dataset represented by an input group representation into input layers connected to a Group Representation Network (GRepsNet), transform the input dataset by using the GRepsNet configured to generate an output dataset represented by an output group representation from the input dataset, wherein the GRepsNet is designed to be equivariant to a predetermined transformation group. Then the one or more processors output the output dataset to the target database from output layers connected to the GRepsNet.

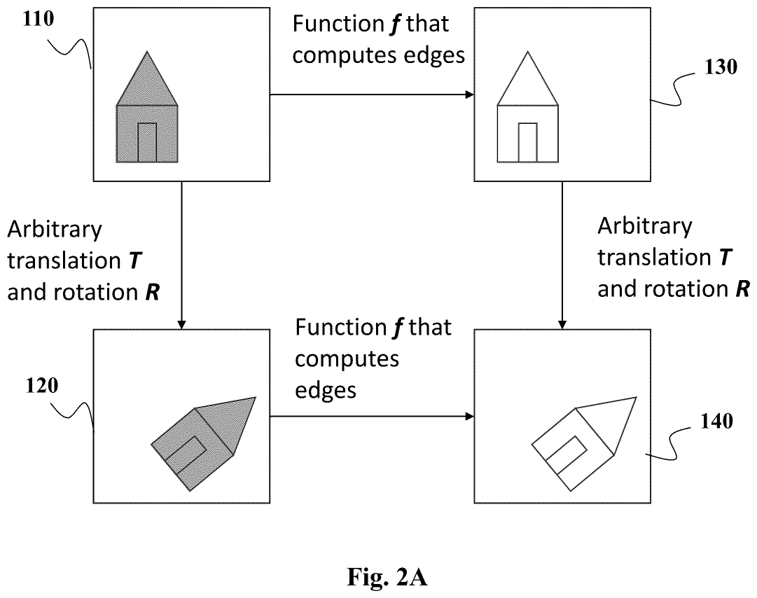

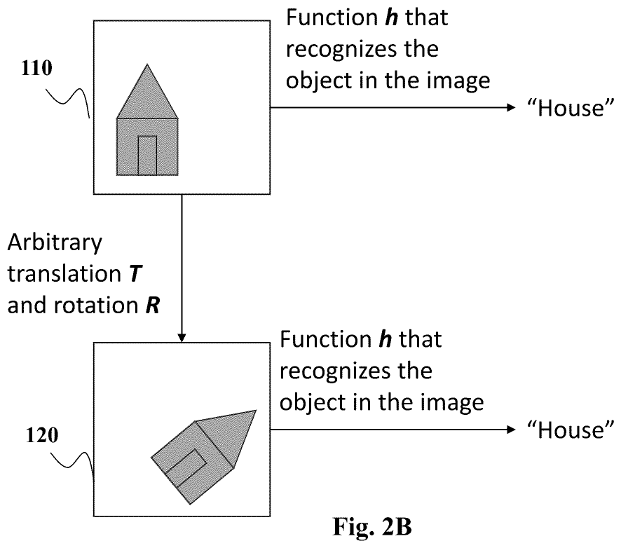

FIG. 2A shows an example of an invariant function equivariant to translations and rotations, according to embodiments of the present invention. The figure illustrates group equivariance through an example that shows an example of equivariance to translations and rotations. Here, the function ƒ is equivariant to translations and rotations. The translation and rotation applied at the input is reflected at the output. The function that computes edges in an image is denoted as f, then it is desirable that when input rotates, the edge map output from f also rotates by the same amount. That means that the function ƒ should be equivariant to rotations. In general, a function ƒ that takes in inputsxbelonging to a set X, is equivariant to a group G, if for all g in the group G, we have f(g(x))=g(f(x)).

FIG. 2B shows an example of an invariant function equivariant to translations and rotations according to some embodiments of the present invention. The figure illustrates the concept of group invariance, showing an example of invariance to translations and rotations. Here, the function h recognizes the object in the image, and is invariant to translations and rotations. The output of h is the same irrespective of the input translation and rotation applied to the input. As the example, consider the application of image recognition. The object in the image is the same irrespective of the rotation and/or translation applied at the input. That is the image classification function h should be invariant to input rotations and translations. In general, for a set of inputs X whose elements are denoted as x, and a group G whose elements are denoted as g, a function h is invariant to the action of G if for allxbelonging to X, for all g belonging to G, h(g(x))=h(x).

Group equivariance and invariance are important desirable properties in order to design robust machine learning systems that use neural networks. Group equivariance plays a key role in the success of several popular architectures such as translation equivariance in Convolutional Neural Networks (CNNs) for image processing, 3D rotational equivariance for point clouds, and equivariance to arbitrary groups in Group Convolutional Neural Networks (GCNNs).

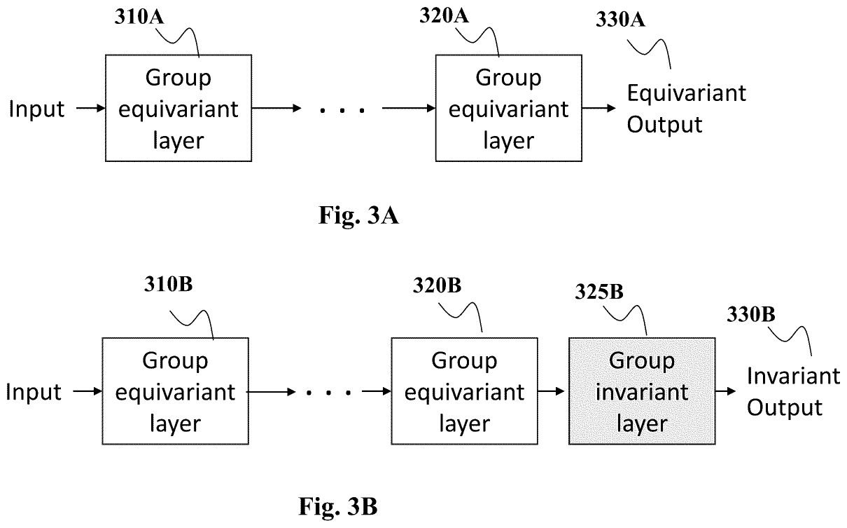

FIG. 3A and FIG. 3B show the general architecture for deep equivariant neural networks. FIG. 3A illustrates a general architecture of a deep equivariant neural network with equivariant output 330A. Each layer of and equivariant neural network is equivariant to a group of transformations. FIG. 3B illustrates a general architecture of a deep equivariant neural network with invariant output 330B. Each layer of the equivariant neural network is equivariant to a group of transformations. Invariance at the output can be achieved by pooling over the group dimensions in the output. Such a neural network consists of multiple layers, each of which is equivariant to the group of interest. When equivariant layers are stacked one after the other, the output of the stack is still equivariant to the group. If invariance is needed at the output, an additional layer, usually a pooling layer, is added to pool the outputs over the group dimension to create the invariant output.

Some embodiments of the present invention are motivated to overcome the following technological issues.

Designing efficient equivariant networks can be challenging both because they require domain-specific knowledge and can be computationally inefficient. E.g., there are several works designing architectures for different groups such as the special Euclidean group SE(3), special Lorentz group O(1, 3), discrete Euclidean groups, etc. Moreover, some of these networks can be computationally inefficient, prompting the design of simpler and lightweight equivariant networks such as E(n) equivariant graph neural networks for graphs and vector neurons for point cloud processing.

Recent work proposes an algorithm to construct equivariant MLPs (EMLPs) for arbitrary matrix groups when the data is provided using tensor polynomial representations. This method directly computes the basis of the equivariant MLPs and requires minimal domain knowledge. Although elegant, EMLPs are restricted to MLPs or can be used as subcomponents in larger networks, and are not useful for making more general architectures equivariant as a whole. Moreover, using equivariant basis functions can often be computationally expensive leading to several group-specific efficient architectures. Whereas recent works have shown that scaling non-equivariant models can produce competitive results to equivariant models.

### Architecture

The construction of the GRepsNet layer is first described. The GRepsNet model is then constructed by stacking several GRepsNet layers. Let the input to a GRepsNet layer be of type ⊕_{i∈N} aᵢTᵢ, where aᵢs are scalars indicating that the input has aᵢ tensors of type Tᵢ.

Each GRepsNet layer further has several Tᵢ-layers for simplicity. Each Tᵢ layer performs two operations: a) converting the input tensors to appropriate tensor types, b) process the converted tensors using a neural network layer, such as an MLP or a CNN. If the representations used are not regular representations, it is assumed that the input to the GRepsNet model always consist of some tensors with T₁ representations, which is not a strong assumption that helps keep our construction simple.

Since the system and the computer-implemented method of the present disclosure provide simpler and steerable networks compared to the generally known architecture, the computational efficiency of the computer/processor used in the system is significantly improved, and the computing performance can be significantly improved, and thus the power consumption of the computer (processor and memory) can be reduced.

Convert tensor types The input to a Tᵢ-layer converts all inputs of types Tⱼ, j≠i along with T₁, T₀ (when available) to type Tᵢ before passing it through an appropriate neural network layer, such as an MLP or a CNN.

The input type Tⱼ is converted to Tᵢ only when i>j>0 or i=0. Otherwise, Tⱼ is not used in the Tᵢ-layer. When i>j>0, i is written as i=kj+r, where k∈N and r<j. The Tᵢ tensor is obtained using Tⱼ, T₁, and T₀ as Tⱼ^{⊗k}⊗T₁^{⊗r}.

When i=0, each input of type Tⱼ is converted to type T₀ by using an appropriate invariant operator, e.g. Euclidean norm for Euclidean groups. These design choices keep the design lightweight as well as expressive as confirmed empirically. Details on how these inputs are processed is described next.

Process converted tensors When not using regular representations, first, the T₀-layer passes all the tensors of type T₀ or scalars through a neural network such as an MLP or a CNN. Since the inputs are invariant scalars, hence, the outputs are always invariant and thus, there are no restrictions on the neural network used for the T₀-layer.

The output from the T₀-layer is called Y_{T}_{₀}. For a Tᵢ-layer with i>0, we simply pass it through a linear neural network with no point-wise non-linearities or bias terms to ensure that the output is equivariant. Lets call this output H_{T}_{ᵢ}. Then, to mix the Tᵢ tensors with the T₀ tensors better, we update H_{T}_{ᵢ} as

$${H}_{{T}_{i}} = {H}_{{T}_{i}} * \frac{{Y}_{{T}_{o}}}{inv ( {H}_{{T}_{i}} )} ,$$

where inv(·) is simply an invariant function such as the Euclidean norm for an Euclidean group. Finally, we pass H_{T}_{ᵢ} through another linear layer without any bias or pointwise non-linearities to obtain Y_{T}_{ᵢ}.

When using regular representations for a discrete group of size |G|, the neural networks used also contain pointwise non-linearities and biases, as they do not affect the equivariance for regular representation.

### Summary of Steps in a Tᵢ-Layer:

a) converting all input representation to Tᵢ,
b) scalar mixing all Tᵢ representation tensors and non-linearities are used only for regular representations i.e. in the case of images.
c) T₀-layers always consist of pointwise non-linearities such as ReLU.

The architecture is naturally equivariant because scalar mixing of tensors and non-linearities ( ) on T₀ preserve equivariance. For regular representations, non-linearities preserve equivariance.

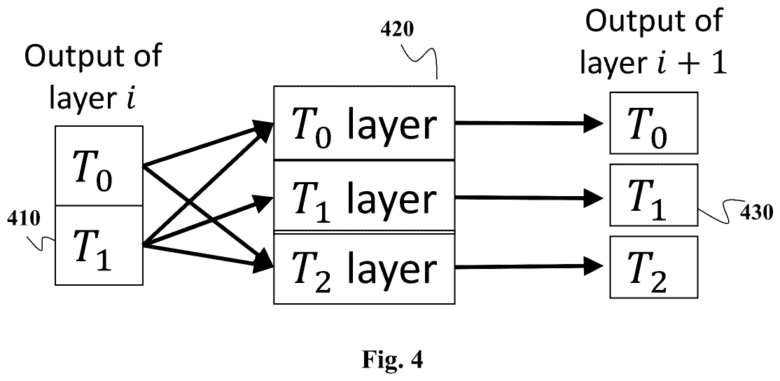

FIG. 4 shows an example of a GRepsNet layer where the input representation is expressed by T₀⊕T₁, and the output representation can be expressed by T₀⊕T₁⊕T₂.

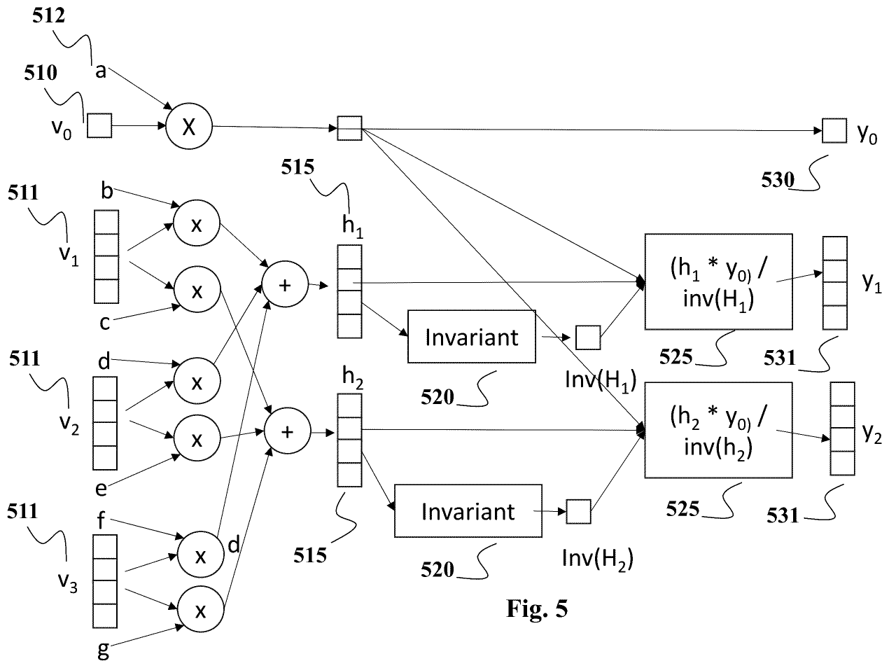

FIG. 5 shows an example of a GRepsNet layer with 1 T₀ (scalar) 510, 3 T₁ (vector) inputs of 4 elements 511, and one T₀ output 530 and two Tᵢ outputs 531. The tensors are processed internally such that the output remains equivariant. In this case, parameters a,b,c,d,e,f 512 are scalars and are the trainable parameters (weights) in the layer. The input tensors are linearly combined to form intermediate representations 515. The “invariant” computation 520 is non-linear (e.g. Euclidean or Minkowski norm, depending on the transformation group). The invariant then interacts with both the intermediate output of the linear combination from the T₁ tensors as well as the T₀ tensor 525.

### The Proof of Equivariance of GRepsNet Architecture

As stacking equivariant layers preserve the equivariance of the resulting model, the equivariance of the GRepsNet model follows directly.

First consider regular representation. Note that the group dimension is treated like a batch dimension in regular representations for discrete groups. Thus, any permutation in the input naturally appears in the output, hence, producing equivariant output.

Now consider non-regular representations considered in the present disclosure, e.g., matrix-based representations. FIG. 4 shows an example GRepsNet layer with inputs of types T₀, T₁ and T₂, and outputs of the same type. The Tᵢ-layer first converts all the inputs to type Tᵢ following which it is processed by a neural network layer such as MLP. FIG. 4 illustrates a case assuming that the input to a GRepsNet layer consists of tensors of types T₀, T₁, . . . , Tₙ, note that the output of the T₀-layer is invariant, following which the Tᵢ-layer outputs equivariant Tᵢ tensors.

The output of the T₀-layer is clearly invariant since all the inputs to the network are of type T₀, which are already invariant.

Now, focus on a Tᵢ-layer. Recall that a Tᵢ layer consists only of linear networks without any bias terms or pointwise non-linearities. Suppose the linear network is given by a stack of linear matrices. Any such linear combination performed by a matrix preserves equivariance, hence, stacking these matrices would still preserve equivariance of the output. Let the input tensor of type Tᵢ be X∈ [symbol] ^{c×k}, i.e., there are c tensors of type Tᵢ and size of the representation of each tensor equals to k. Consider a matrix W∈ [symbol] ^{c′×c}, which multiplied with X gives Y=W×X∈ [symbol] ^{c′×k}, where Y is a linear combination of the c input tensors each of type Tᵢ. Let the group transformation on the tensor Tᵢ be given by G∈ [symbol] ^{k×k} Then the group transformed input is given by X′=X×G∈ [symbol] ^{c×k}. The output of X′ through the Tᵢ-layer is given by Y′=W×X×G∈ [symbol] ^{c′×k}=(W×X)×G=Y×G, where the second last equality follows from the associativity property of matrix multiplication. Thus, each Tᵢ-layer is equivariant.

### Synthetic Experiments Related to EMLP

Three regression tasks are used for comparison with EMLP and MLP: the O(5)-invariant regression, O(3)-equivariant regression, and O(1, 3)-invariant regression. The (input types, output types) corresponding to these tasks are (2T₁, T₀), (5T₀+5T₁, T₂), and (4T₁, T₀). Architectures with the given input and output types are used following the GRepsNet design. As described, once the tensor types are converted, we process the tensors using some neural networks. Here we use simple MLPs for this processing task.

### O(5)-Invariant Model

The input consists of two tensors of T₁ type that is passed through the first layer consisting of T₀-layers and T₁-layers. All Tᵢ layers are made of MLPs. The number of output tensors is equal to the channel size in some embodiments. This is followed by three similar layers consisting of T₀-layers and T₁-layers, all of which takes as input T₁ tensors, and output tensors of the same type. Additionally these layers use residual connections. Finally, the T₁ tensors are converted to T₀ tensors by taking their norms, which is passed through a final T₀-layer that gives the output.

### O(3)-Equivariant Model

The input consists of 5 tensors each of type T₀ and T₁. The first layer of the model converts them into tensors of type T₀+T₁+T₂. The number of tensors obtained is equal to the channel size in some embodiments. It is followed by two layers of input and output types T₀+T₁+T₂. These layers also use residual connections. Then, the T₂ tensors of the obtained output is passed through another T₂ layer, which gives the final output.

### O(1, 3)-Invariant Model

This design closely follows the design of the O(5)-invariant network above except the invariant tensors is obtained using Minkowski norm instead of the Euclidean norm.

Image classification with MLP-mixers

A rotation-equivariant neural network architecture is now described within the GRepsNet framework.

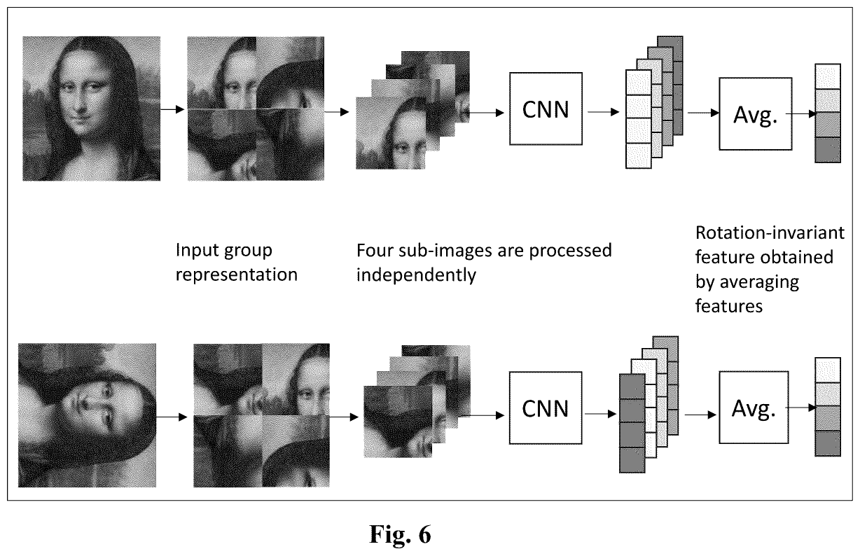

FIG. 6 shows an example of building group representations for the image classification experiments for the C4 group(group of discrete rotations 0, 90, 180, 270 degrees). The figure shows how equivariance is achieved using the right input representation and how rotation-invariance is obtained by averaging the features of the four sub-images in the input representation. In this case, datasets CIFAR10 with random 90° rotations, which we call rot90-CIFAR10, along with Galaxy10 and EuroSAT datasets that have naturally 90° symmetries in them are used for testing this network.

The images are converted to T₁ tensors of the group C4 of 90° rotations efficiently which makes the design more efficient than the traditional regular representations, e.g., used in Equitune by repeating transformed images in the input. Once the regular T₁ representations are obtained, an additional group dimension in the data is obtained in addition to the batch, channel, and spatial dimensions. The group dimension is treated like the batch dimension.

MLP-mixers are constructed using eight layers, each containing two smaller layers: a spatial MLP-mixer layer with hidden dimension 64 and a channel MLP-mixer layer with hidden dimension 512. Two designs of GRepsMLP-mixers are provided: GRepsMLP-mixer-1 and GRepsMLP-mixer-2, where GRepsMLP-mixer-1 always treats the group dimension like a batch dimension, whereas GRepsMLP-mixer-2 additionally uses a non-parametric fusion amongst the features in the group dimension. Here, a layernorm along the group dimension without any learnable parameters is used as the fusion layer.

The construction of T₁ tensors from input images is now described. Given an imagex∈ [symbol] ^{2d×2d}, it can be written as

$$x = [ \begin{matrix}{x}_{1} & {x}_{2} \\ {x}_{4} & {x}_{3}\end{matrix} ] ,$$

where xᵢ∈ [symbol] ^{d×d} for i∈{1 , . . . , 4}. Let G={e, g, g², g³} represent the group of 90° rotations. Define the group action of G on x, i.e.

$$gx = [ \begin{matrix}{gx}_{4} & {gx}_{1} \\ {gx}_{2} & {gx}_{3}\end{matrix} ] .$$

The following G representation of x is constructed:

$${( x )}_{G} = [ \begin{matrix}{x}_{1} & {g}^{- 1} {x}_{2} \\ {g}^{- 3} {x}_{4} & {g}^{- 2} {x}_{3}\end{matrix} ] .$$

Each of the four entries in the matrix (x) G are treated as separate channels with no data flowing between except when intra-mixers are used. Further all the channels share the same parameters, say M. Then the output of M would be

$$M ( {( x )}_{G} ) = [ \begin{matrix}M ( {x}_{1} ) & M ( {g}^{- 1} {x}_{2} ) \\ M ( {g}^{- 3} {x}_{4} ) & M ( {g}^{- 2} {x}_{3} )\end{matrix} ] .$$

Equivariance to the four rotations obtained using this representation can now be verified. First, note

$${( g x )}_{G} = [ \begin{matrix}{g}^{- 3} {x}_{4} & {x}_{1} \\ {g}^{- 2} {x}_{3} & {g}^{- 1} {x}_{2}\end{matrix} ] .$$

Then, the output is

$$M ( {( g x )}_{G} ) = [ \begin{matrix}M ( {g}^{- 3} {x}_{4} ) & M ( {x}_{1} ) \\ M ( {g}^{- 2} {x}_{3} ) & M ( {g}^{- 1} {x}_{2} )\end{matrix} ] .$$

Clearly, M((gx)_{G}) is a permutation of

M((x)_{G}). T₀ obtain invariance, the four channels are averaged. This method is computationally more efficient than using four transformed images as input as in the earlier work on equituning. This efficient representation is still able to gain the benefits of group equivariance.

PDE solving with Fourier Neural Operators

It is now demonstrated that rotation equivariant Fourier Neural Operators (FNOs) can be constructed using the GRepsNet framework and utilized for predicting future states in systems that follow partial differential equations.

Two versions of the incompressible Navier-Stokes equation, with and without symmetry with respect to 90° rotations, are used to demonstrate this application.

The group dimension is treated like the batch dimension similar to the case of image classification. Then, the data is sequentially passed through four FNO layers. The ability to directly use various models such as FNOs and still preserving equivariance emphasizes the simplicity of our method.

Two designs of GRepsFNO are described, similar to GRepsMLP-mixers: GRepsFNO-1 and GRepsFNO-2, where GRepsFNO-1 always treats the group dimension like a batch dimension, whereas GRepsFNO-2 additionally uses a non-parametric fusion amongst the features in the group dimension. Here, features are divided in the group dimension by the standard deviation across that dimension. Use of layernorm is avoided here since it requires implementation of layernorm in the complex Fourier domain. Instead, the choice of dividing by the standard deviation is a much simpler alternative serving the same purpose.

For FNOs, the traditional group representation is used, i.e.

$${( x )}_{G} = [ \begin{matrix}x & g x \\ {g}^{3} x & {g}^{2} x\end{matrix} ] .$$

The reasons for this choice here is for FNOs, all the frequency modes are preserved by using transformed inputs

Predicting N-body dynamics using Graph Neural Networks

It is now demonstrated that group-equivariant Graph Neural Networks (GNNs) can be constructed using the GRepsNet framework, called GRepsGNN, and utilized for predicting N-body dynamics.

The problem of predicting dynamics of N charged particles given their charges and initial positions is considered. Each particle is placed at a node of a graph [symbol] ={ [symbol] , ε}, where [symbol] and ϵ are the sets of vertices and edges. Let the edge attributes of [symbol] be aᵢⱼ, and let hᵢ^{l} be the node feature of node vᵢ∈ [symbol] at layer l of a message passing neural network (MPNN). An MPNN has an edge update, mᵢⱼ=ϕₑ(hᵢ^{l}, hⱼ^{l}, aᵢⱼ) and a node update hᵢ^{l+1}=ϕₕ(hᵢ^{l}, mᵢ), mᵢ= [symbol] mᵢⱼ, where ϕₑ and ϕₕ are MLPs corresponding to edge and node updates, respectively.

The design of GRepsGNN is achieved by modifying the MPNN architecture. In GRepsGNN, two edge updates for T₀ and T₁ tensors are used, respectively, and one node update for T₁ update. The two edge updates are m_{ij ,T}_{₀}=ϕ_{e,T}_{₀}(∥hᵢ^{l}∥, ∥hⱼ^{l}∥, aᵢⱼ), m_{ij,T}_{₁}=ϕ_{e,T}_{₁}(hᵢ^{l}, hⱼ^{l}, aᵢⱼ), where ∥·∥ obtains T₀ tensors from T₁ tensors for the Euclidean group, ϕ_{e,T}_{₀}(·) is T₀-layer MLP, and ϕ_{e,T}_{₁}(·) is a T₁-layer made of an MLP without any pointwise non-linearities or biases. The final edge update is obtained as mᵢⱼ=m_{ij,T}_{₁}*m_{ij,T}_{₀}/∥m_{ij, T}_{₁}∥. Finally, the node update is given by hᵢ^{l+1}=ϕ_{h,T}_{₁}(hᵢ^{l}, mᵢ), where mᵢ= [symbol] mᵢⱼ and ϕ_{h,T}_{₁}(·) is an MLP without any pointwise non-linearities or biases. Thus, the final node update is a T₁ tensor.

Equivariant Finetuning with T₂ Representations

Here, it is demonstrated that T₂ representation of features extracted by CNNs serves as better equivariant features than T₁ representations such as used in equitune. This is based on the intuition that T₂ representations have better mixing amongst features in the group dimension than T₁ representations. This is because, T₂ representation stems from the outer product of two T₁ representations. This is also similar to the use of outer products in the features by Bilinear CNNs leading to efficient processing of features for fine-grained classification. The approach of GRepsNet presented in this disclosure differs from Bilinear CNNs in that our outer product is in the group dimension that preserves equivariance, whereas the Bilinear CNNs work is not concerned with group equivariance.

rot90-CIFAR10 is first used to test the hypothesis that T₂ representation provide better performance than T₁ representations. A CNN with 3 convolutional layers followed by 5 linear layers is used. The initial k layers of the network use T₁ representation, following which all layers use T₂ representations. It is verified that best performance is obtained when the last few layers use T₂ representations.

Based on this observation, T₂-equitune is constructed, that extracts T₁ features from pretrained models, but converts them to T₂ representations before providing invariant outputs. Pretrained Resnet18 is finetuned on rot90-CIFAR10 and Galaxy10 datasets. It is demonstrated that T₂-equitune outperforms equitune by using T₂ representations in the extracted features.

### Additional Network Designs

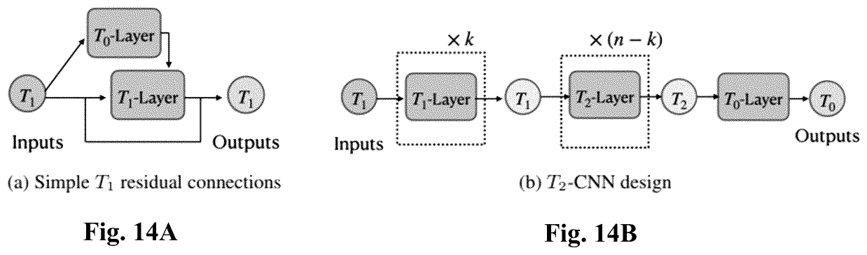

FIG. 14A shows an example embodiment of GRepsNet where residual connections are added in a GRepsNet layer. FIG. 14B shows an example embodiment of GRepsNet architecture with T₂ representations. First k layers consist of T₁-layers, then the extracted features are converted into T₂ tensors, which are then processed by T₂-layers. Finally T₀ tensors, i.e., scalars are obtained as the final output. In this case, it shows the architecture used for T₂ CNNs and equituning, where the first k layers are made of T₁-layers to extract features, then the extracted features are converted in T₂ tensors, which are then processed by T₂-layers. Finally T₀ tensors, i.e., scalars are obtained as the final output.

### Datasets and Experiments

Comparison with EMLPs

Datasets: Three regression tasks are considered here: O(5)-invariant task, O(3)-equivariant task, and O(1, 3) invariant task. In O(5)-invariant regression task, we have input X={xᵢ}ᵢ₌₁² of type 2T₁ and output

$$f ( {x}_{1} , {x}_{2} ) = sin ( ‖ {x}_{1} ‖ ) - {‖ {x}_{2} ‖}^{3} / 2 + \frac{{x}_{1}^{T} {x}_{2}}{‖ {x}_{1} ‖ ‖ {x}_{2} ‖} of type {T}_{0} .$$

Then, for O(3)-equivariant task, input X={(mᵢ, xᵢ)}ᵢ₌₁⁵ of type 5T₀+5T₁ corresponding to 5 masses and their positions. The output is the inertia matrix [symbol] =Σᵢmᵢ(xᵢ^{T}xᵢI−xᵢxᵢ^{T}) of type T₂. Finally, for the O(1, 3)-equivariant task, we consider the electron-muon scattering(e⁻+μ³¹→e⁻+μ⁻) task. Here, the input is of type 4T_{(1,0)} corresponding to the four momenta of input and output electron and muon, and the output is the matrix element, which is of type T_{(0,0)}.

Experimental setup: MLPs, EMLPs, GRepsNet are trained on the datasets discussed above with varying sizes for 100 epochs. For each task and model, model sizes between small (with channel size 100) and large (with channel size 384) are chosen. Learning rate is chosen from {10⁻³, 3×10⁻³}. In general, MLPs and EMLPs provide best result with the large model size, whereas GRepsNets produce better results with small model sizes.

In the O(5)-invariant regression task, for MLPs and EMLPs, a learning rate of 3×10⁻³ and channel size 384 are used. Whereas for GRepsNets, a learning rate of 10⁻³ and channel size 100 is employed. For the O(3)-equivariant task, learning rate 10⁻³ and channel size 384 is used for all the models. For the O(1, 3)-invariant regression task, a learning rate of 3× 10⁻³ yields best results for all the models. Further, channel size of 384 for MLPs and EMLPs, whereas for GRepsNets, a channel size of 100 are chosen for best results.

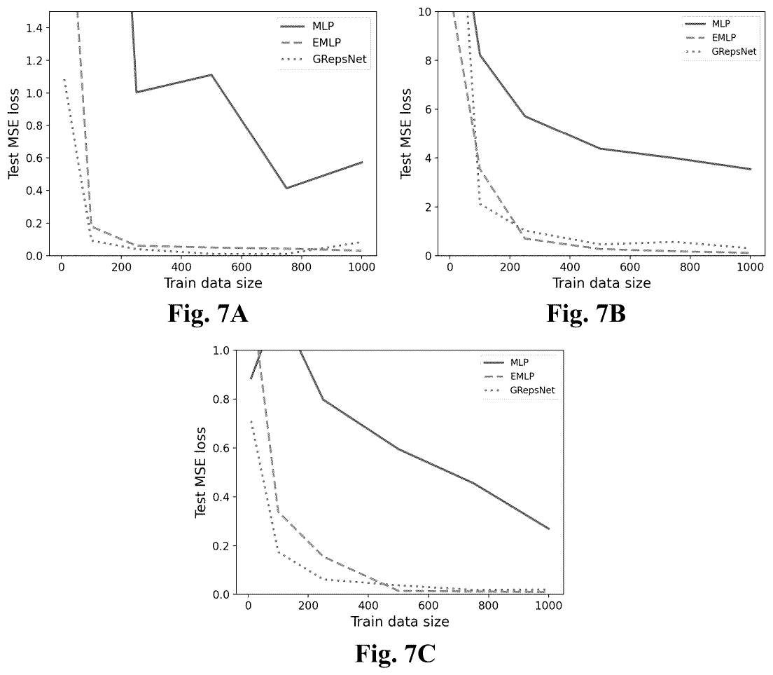

Observations and results: FIG. 7A, FIG. 7B, and FIG. 7C show comparison of GRepsNets with EMLPs and MLPs. FIG. 7A shows O(5)-invariant synthetic regression task with input type 2T₁ and output type T₀, FIG. 7B shows O(3)-equivariant regression with input as masses and positions of 5 point masses using representation of type 5T₀+5T₁ and output as the inertia matrix of type T₂, and FIG. 7C shows SO(1, 3)-invariant regression computing the matrix element in electron-muon particle scattering with input of type 4T₁ and output of type T₀.

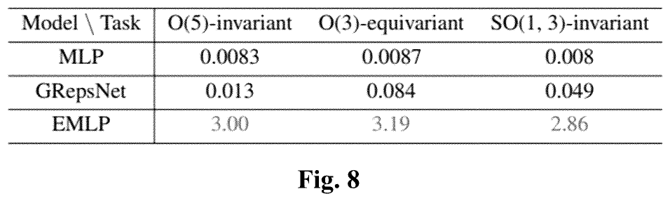

From FIG. 7A, FIG. 7B, and FIG. 7C, across all the tasks, GRepsNets perform competitively to EMLPs and significantly outperform non-equivariant MLPs. These figures also show that GRepsNets need far less data to get the same performance compared to MLPs. FIG. 8 shows comparisons of the training time for GRepsNet, MLP, and EMLP for different tasks, according to embodiments of the present invention; Train time per epoch(in seconds) for models with the same channel size of 384 for datasets of size 1000. GRepsNets provide the same equivariance as EMLPs but much lower compute cost that is comparable to MLPs. GRepsNet are computationally much more efficient than EMLPs, while being only slightly more expensive than naive MLPs. This shows that GRepsNet can provide competitive performance to EMLPs on equivariant tasks. Moreover, the lightweight design of GRepsNets motivates its use in larger datasets.

MLPs and GRepsNets have comparable time per epoch, whereas EMLPs take huge amount of time. Hence, EMLPs, despite its excellent performance on equivariant tasks, is not scalable to larger datasets of practical importance; train time per epoch(in seconds) for models with the same channel size of 384 for datasets of size 1000. GRepsNets provide the same equivariance as EMLPs but much lower compute cost that is comparable to MLPs.

Image Classification with MLP-Mixers

Given an input image, the system is required to classifiy it into one of a predetermined set of classes.

Datasets and Experimental Setup: rot90-CIFAR10(CIFAR10 with random rot90 transformations), Galaxy10 and EuroSAT image datasets are used for experiments on image classification. Note that, for these datasets, the input images have no preferred orientation, and the orientation is a nuisance variable, and rotation-invariant features are desirable for classification. Non-equivariant MLP-Mixers are compared with two preferred embodiments in the present disclosure using rot90-equivariant MLP-Mixers with T₁ representations: GRepsMLP-Mixer-1 and GRepsMLP-Mixer-2. GRepsMLP-Mixer-2 simply adds non-parametric early fusion operations in the group dimension to the GRepsMLP-Mixer-1 architecture. Each model has 8 mlp-mixer layers with patch size 16 for the Galaxy10 dataset and a patch size of 4 otherwise. Each model is trained for 100 epochs with learning rate 10⁻³ with 5 warmup epochs

In each of the models, every layer further consists of two smaller layers: a) one that applies a layernorm followed by two-layered MLP on the channel dimension, and b) another that applies layernorm followed by two-layered MLP on the spatial dimension, as done in traditional MLP-Mixers. For GRepsMLP-Mixer-1 in the present invention, the traditional scalar representations of MLP-Mixers are replaced by T₁ representations. For GRepsMLP-Mixer-2, we additionally add early fusion layer with no additional parameters. The early fusion layer is constructed as follows: the four different components of the T₁ representation for the rot90 group is fused using a simple layernorm applied along this group dimension of the T₁ representation of size four.

For training non-equivariant and equivariant MLP-Mixer models, each of the models is trained for 100 epochs with batch size 128 and learning rate 10⁻³ and use 5 warmup epochs with minimum learning rate 10⁻⁶, use cosine scheduler and Adam optimizer with(β₁, β₂)=(0.9,0.99), weight decay 5×10⁻⁵.

Results and Observations: Table 2 shows that GRepsMLP-Mixer models clearly outperform non-equivariant MLP-Mixer across all datasets. And benefits of group equivariance are observed. Note that the early fusion layer in GRepsMLP-Mixer-2 helps outperform GRepsMLP-Mixer-1 in two datasets and is competitive with GRepsMLP-Mixer-1 in general. Hence, fusing the features early on helps in general.

Solving PDEs with FNOs

The models described in the present invention use regular T₁ representations with the architecture kept near-identical to the FNO model used. GRepsFNO-2 uses additional early fusion layers from in addition to the late fusion layer present in GRepsFNO-1.

Datasets and Experimental Setup: Two versions of the incompressible Navier-Stokes equation are considered. The first version is a Navier-Stokes equation without any symmetry (NS dataset) in the data, and a second version that does have 90° rotation symmetry (NS-SYM dataset). The general Navier-Stokes equation considered is written as,

$$i ) {\partial }_{t} w ( x , t ) + u ( x , t ) \cdot ∇ w ( x , t ) = v Δ w ( x , t ) + f ( x ) , ii ) ∇ \cdot u ( x , t ) = 0 and w ( x , 0 ) = {w}_{0} ( x ) ,$$

where w(x,t)∈ [symbol] denotes the vorticity at point (x,t), W₀(x) is the initial velocity, u(x,t)∈ [symbol] ² is the velocity at (x,t), and v=10⁻⁴ is the viscosity coefficient. f denotes an external force affecting the dynamics of the fluid. The task here is to predict the vorticity at all points on the domain x∈[0,1]² for some t, given the previous values of vorticity at all point on the domain for previous T steps. When f is invariant with respect to 90° rotations, then the solution is equivariant, otherwise not. For non-invariant force, f(x₁, x₂)=0.1 (sin(2π(x₁+x₂))+cos(2π(x₁+x₂))) and as invariant force, fᵢₙᵥ=0.1 (cos(4πx₁)+cos(4πx₂)). We use T=20 previous steps as inputs for the NS dataset and T=10 for NS-SYM and predict for t=T+1. Models are trained with batch size 20 and learning rate 10⁻³ for 100 epochs.

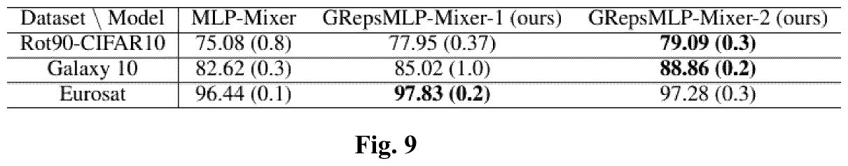

Results and Observations: FIG. 9 shows the image classification results on three datasets for MLP-Mixer, GRepsMLP-Mixer-1 and GRepsMLP-Mixer-2, according to embodiments of the present invention. The figure shows Mean (std) of relative mean square errors in percentage over 3 seeds. In this case, Mean (std. deviation) of test accuracies over 3 runs with different random initialization of network weights for the image classification experiments. Both GRepsMLP-Mixer-1 and GRepsMLP-Mixer-2 use regular T1 representations, with architecture nearly identical to MLP-Mixer used. GRepsMLP-Mixer-2 uses a simple early fusion module in addition to late fusion present in GRepsMLP-Mixer-1. GRepsMLP-Mixers clearly outperform MLP-Mixers. Both GRepsFNO-1 and GRepsFNO-2 (with early fusion) clearly outperforms traditional FNOs on both datasets NS ans NS-SYM. Note that the NS dataset do not have rot90 symmetries and yet GRepsFNOs outperforms FNOs showing that using equivariant representations may be more expressive for tasks without any obvious symmetries as was also noted in prior works. Moreover, we find that the GRepsFNO models perform competitively with the more sophisticated, recently proposed, G-FNOs. Thus, we gain benefits of equivariance with by using equivariant representations and making minimal changes to the architecture.

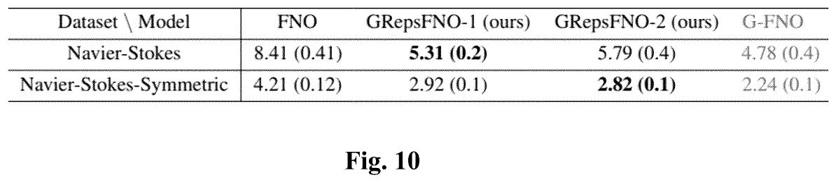

FIG. 10 shows the results of solving PDEs. It compares the performance between FNO, GFNO, GRepsFNO-1 and GRepsFNO-2, according to embodiments of the present invention; Mean (std. deviation) of relative mean square errors in percentage over 3 runs with different random initialization of network weights for the PDE solving experiments. GRepsFNO uses T1 representations with the architecture kept near-identical to the FNO model. GRepsFNO-2 uses early fusion layers in addition to the late fusion layer present in GRepsFNO-1. GRepsFNO outperforms FNO which is not equivariant, and performs competitively with the more complex G-FNO that uses group convolutions.

Modelling a Dynamic N-Body System with GNNs

Datasets and Experimental Setup: N-body dynamics dataset is used, where the task is to predict the positions of N=5 charged particles after T=1000 steps given their initial positions ∈ [symbol] ^{{3×5}}, velocities ∈ [symbol] ^{{3×5}}, and charges ∈{−1,1}⁵. 3000 trajectories are used for training, 2000 trajectories for validation, and 2000 for test. Both EGNN and GRepsGNN models have 4 layers, and were trained for 10000 epochs. Recall that GRepsGNN was designed by replacing the scalar representations in MPNN with T₀+T₁ representations and their appropriate mixing.

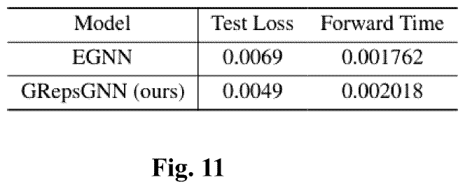

Results and Observations: FIG. 11 shows the comparison of the performances between GRepsGNN and EGNN for the experiment on predicting N-body dynamics, according to embodiments of the present invention. In this case, GRepsGNN provides comparable test loss and run time complexity compared to EGNN for predicting N-body dynamics. GRepsGNN is constructed by replacing the representation in the GNN architecture with T1 representations along with tensor mixing, whereas EGNN is a specialized GNN designed for E(n)-equivariant tasks. From the figure, we note that GRepsGNN perform competitively to EGNN on the N-body problem even though EGNN is a specialized architecture for the task. Moreover, it has a comparable computational complexity to EGNN, and hence, it is computationally much more efficient than many specialized group equivariant architectures that uses spherical harmonics for E(n)-equivariance. It also shows previously reported results that EGNN much faster than other equivariant networks such as SE (3) Transformers and outperforms them in test loss performance.

### Second-Order Equituning

In some embodiments of the present invention, We perform two sets of experiments to understand the impact of T₂ representations in on the performance of equivariant image classifiers.

### Datasets and Experimental Setup

As an example of a network with T₂ representations, a rot90-equivariant CNN with 3 convolutional layers followed by 5 fully connected layers is constructed with T₁ representations for the first i layers and use T₂ representations for the rest.

Equituning algorithm that uses T₁ representations is extended to use T₂ representations in the final layers. As a comparative baseline, a pretrained Resnet18 is used as non-equivariant model and perform non-equivariant finetuning and equivariant finetuning with T₁ and T₂ representations. Experiments are performed on rot90-CIFAR10 and Galaxy10 datasets.

The CNN used for training consists of 3 convolutional layers each with kernel size 5, and output channel sizes 6, 16, and 120, respectively. Following the convolutional layers are 5 fully connected layers, each consisting of features of dimension 120. For training from scratch, we train each model for 10 epochs, using stochastic gradient descent with learning rate 10⁻³, momentum 0.9. Further, we also use a stepLR learning rate scheduler with γ 0.1, step size 7, which reduces the learning rate by a factor of γ after every step size number of epochs. The T₂ layers are computed by simply taking an outer product of the T₁ features at the desired layer where T₂ representation is introduced, following which, we simply use the same architecture as for T₁ representation. Equivariance is maintained for both T₁ and T₂ regular representations.

The pretrained Resnet18 is finetuned for 5 epochs, using stochastic gradient descent with learning rate 10⁻³, momentum 0.9. For equivariant finetuning with T₂ representations, T₁ features are first extracted from the pretrained model same as done for equituning, following which they are converted to T₂ representations using a simple outer product. Once the desired features are obtained, they are passed through two fully connected layers with a ReLU activation function in between to obtain the final classification output.

### Results and Observations

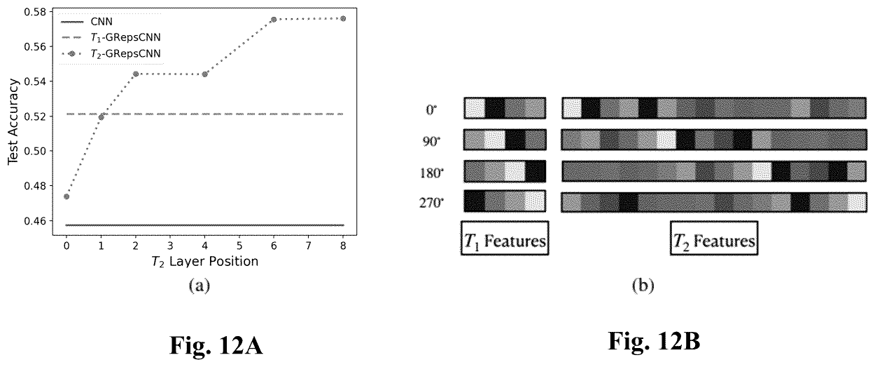

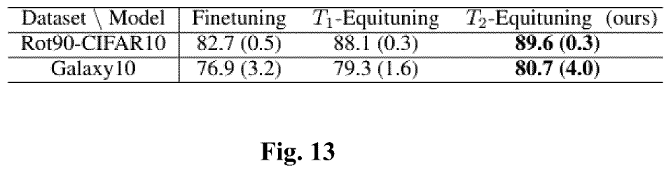

FIG. 12A shows the performance of a rot90-equivariant CNN with 3 convolutional layers and 5 fully connected layers on rot90-CIFAR10. Here, T₂ representations are introduced in layer i ∈[1, . . . , 8]. Using T₂ representations in the final layers of the CNN outperforms non-equivariant CNNs as well as traditional equivariant representations with T₁ representations; this shows the effect of using T₂ representations for rot90-CIFAR10 classification, using T₂ representations in the final layers of the CNN easily outperforms non-equivariant CNNs as well as equivariant models with only T₁ representations. FIG. 12B shows the T₁ and T₂ features obtained from one channel of a pretrained Resnet corresponding to T₁-equitune and T₂-equitune, respectively. FIG. 13 shows the comparison of the results for Equituning with T1 versus T2 representations, according to embodiments of the present invention; Mean (std. deviation) for test accuracies for Equituning using a pretrained Resnet with Rot90-CIFAR10 and Galaxy10 datasets. Extending Equituning using T2 representations outperforms the earlier version that uses only T1 representations.

From FIG. 13, using T2 representations in the later layers of the same network significantly outperforms both non-equivariant and well as equivariant T1-based CNNs. On both rot90-CIFAR10 and Galaxy10, T2-equitune outperforms equitune, confirming that T2 representations in the features lead to powerful equivariant networks.

### Exemplar Robust Machine Learning System

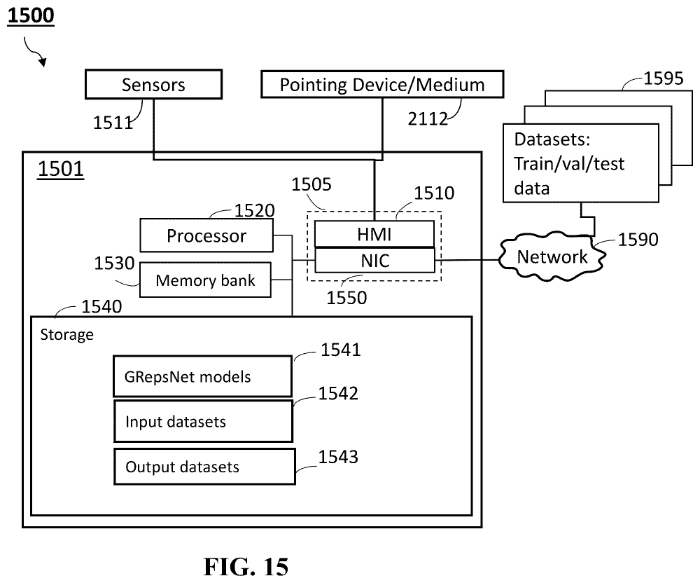

FIG. 15 shows an exempler schematic of a robust machine learning system configured with processor, memory and interface, according to some embodiments. Specifically, FIG. 15 is a block diagram illustrating an example of a system. The system 1500 includes a machine learning device 1501, having a set of interfaces and data links 1505 configured to receive and send signals (digital datasets), at least one processor 1520, a memory (or a set of memory banks) 1530 and a storage 1540. The processor 1520 performs, in connection with the memory 1530, computer-executable programs and algorithms (instructions) stored in the memory 1530 and the storage 1540. The set of interfaces and data links 1505 includes a human-machine interface (HMI) 1510 and a network interface controller 1550. The processor 1520 can perform the computer-executable programs and algorithms in connection with the memory 1530 that uploads the computing instructions, computer-executable programs, and algorithms from the storage 1540. The instructions, computer-executable programs, and algorithms stored in the storage 1540 use deep neural networks in the form of GRepsNets 1541, input datasets 1542, output datasets 1543.

The processor 1520 is configured to, in connection with the interface and the memory banks 1505, generate/output the signals and the datasets 1595 into GRepsNet blocks 1541 to train the machine learning device 1501 using the datasets 1595 via the network 1590.

The system 1500 receives signals (datasets) from a set of sensors 1511 which can be image sensors, microphones, via a network 1590 and the set of interfaces and data links 1505, as well as other interface modules such as pointing device/medium 1512.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. Such processors may be implemented as integrated circuits, with one or more processors in an integrated circuit component. Though, a processor may be implemented using circuitry in any suitable format.

Also, the embodiments of the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

What is claimed is:

1. A non-transitory computer-readable medium having stored thereon a set of instructions for data transformations, which if performed by one or more processors, cause the one or more processors to at least:
provide an input dataset represented by an input group representation into input layers connected to a Group Representation Network (GRepsNet);
transform the input dataset by using the GRepsNet configured to generate an output dataset represented by an output group representation from the input dataset, wherein the GRepsNet is designed to be equivariant to a predetermined transformation group; and
output the output dataset from output layers connected to the GRepsNet.

2. The non-transitory computer-readable medium of claim 1, wherein the GRepsNet is formed by one or more linear neural layers with no point-wise non-linearities or bias terms when the input group representation is first or higher-order tensors, wherein the linear neural layers combine the input group representation with the output group representation linearly which maintains equivariance to the predetermined transformation group.

3. The non-transitory computer-readable medium of claim 2, wherein the GRepsNet is configured to create additional higher-order group representations.

4. The non-transitory computer-readable medium of claim 2, wherein the GRepsNet is formed by one or more invariant non-linearities applied to the outputs of linear neural layers, wherein the outputs of the non-linearities are configured to interact with the output of the linear neural layers and maintain the equivariance to a predetermined transformation group, wherein the invariant non-linearities are represented by Euclidean norm.

5. The non-transitory computer-readable medium of claim 1, wherein the GRepsNet consists of multiple layers, wherein each of the multiple layers is equivariant to the predetermined transformation group.

6. The non-transitory computer-readable medium of claim 1, wherein when an invariance is required at the output dataset, a pooling invariant layer is additionally arranged at the output layers to pool over group dimensions in the output dataset.

7. A data transformation system, comprising:
a memory configured to store a Group Representation Network (GRepsNet) and a set of instructions for data transformations using the GRepsNet; and
a processor coupled to the memory and configured to perform the set of instructions including steps of:
providing an input dataset represented by an input group representation into input layers connected to a Group Representation Network (GRepsNet);
transforming the input dataset by using the GRepsNet configured to generate an output dataset represented by an output group representation from the input dataset, wherein the GRepsNet is designed to be equivariant to a predetermined transformation group; and
outputting the output dataset from output layers connected to the GRepsNet.

8. The data transformation system of claim 7, wherein the GRepsNet is formed by one or more linear neural layers with no-point wise non-linearities or bias terms when the input group representation is first or higher order tensors, wherein the linear neural layers combine the input group representation with the output group representation linearly.

9. The data transformation system of claim 8, wherein the GRepsNet is configured to create additional higher-order group representations.

10. The data transformation system of claim 8, wherein the GRepsNet is formed by one or more invariant non-linearities applied to the outputs of linear neural layers, wherein the outputs of the non-linearities are configured to interact with the output of the linear neural layers and maintain the equivariance to a predetermined transformation group, wherein the invariant non-linearities are represented by Euclidean norm.

11. The data transformation system of claim 7, wherein the GRepsNet consists of multiple layers, wherein each of the multiple layers is equivariant to the predetermined transformation group.

12. The data transformation system of claim 7, wherein when an invariance is required at the output dataset, a pooling invariant layer is additionally arranged at the output layers to pool over group dimensions in the output dataset.
